(19) United States
(12) Patent Application Publication
(10) Pub. No.: US 2021/0327068 A1
(43) Pub. Date: Oct. 21, 2021

(54) Methods for Automated Lesion Analysis in Longitudinal Volumetric Medical Image Studies

(71) Applicant: HighRAD Ltd., Tel Aviv (IL)

(72) Inventors: Leo Joskowicz, Jerusalem (IL); Jacob Sosna, Jerusalem (IL)

(73) Assignee: HighRAD Ltd., Tel Aviv (IL)

(21) Appl. No.: 16/853,854

(22) Filed: Apr. 21, 2020

(30) Foreign Application Priority Data
Apr. 18, 2020 (IL) 274016

(51) Int. Cl. G06T 7/00

(52) U.S. Cl. CPC G06T 7/0016; G06T 2200/24; G06T 2207/20081; G06T 2207/20084; G06T 2207/30096

(57) ABSTRACT

Described herein is a computer implemented method that includes receiving at a data processor two or more digital data files representing medical images of a same modality; performing group-wise 3D registration of the digital data files representing medical images of a same modality; and parallel lesion detection and analysis on the digital data files representing the medical images.

### CROSS-REFERENCE TO RELATED APPLICATIONS

Benefit is claimed to Israel Patent Application No. 274016, filed Apr. 18, 2020, the contents of which are incorporated by reference herein in their entirety.

### FIELD OF THE INVENTION

The invention is in the field of image analysis.

### BACKGROUND OF THE INVENTION

Radiology relies on medical images to diagnose and treat disease and is one of the cornerstones of modern healthcare. More than 1 billion volumetric scans (750 million CT and 200 million MRI) are performed annually in Europe, Asia, and the US. Currently each scan requires a radiologist to view it, analyze it, and to write a radiology report. Radiological follow-up is the interpretation of two or more radiological images acquired over the course of time to evaluate disease progression and to determine treatment efficacy in support of clinical decision-making Radiological follow-up is a key clinical task which is currently performed manually. Approximately 40% of expert radiologist readings involve follow-up image interpretation.

Radiological follow-up reading is significantly different than diagnosis reading: the goal of follow-up reading is to find and quantify the differences between the baseline (previous) and the follow-up (current) image, rather than finding anomalies in a standalone image as in diagnosis reading. The follow-up image changes analysis is patient-specific and requires different clinical and technical approaches than standalone single image interpretation.

Currently, most radiologists quantify the changes between the baseline and the follow-up scans by finding new lesions, by identifying lesions that disappeared, and by estimating the size of existing lesions and their relative change with guidelines based on linear measurements. It has been long established in radiology that volumetric measures are more accurate and reliable than approximations based on linear measurements (Tuma SR. Sometimes size does not matter: reevaluating RECIST and tumor response rate end points. Journal of National Cancer Institute. vol. 98 pp. 1272-1274, 2006. Eisenhauer E, Therasse P, Bogaerts J, Schwartz L H, Sargent D, Ford R, Dancey J, Arbuck S, Gwyther S, Mooney M, Rubinstein L. New response evaluation criteria in solid tumours: revised RECIST guideline (Ver 1.1). European Journal of Cancer. vol. 45(2) pp. 228-47, 2009). However, volumetric measurements require delineating the lesion contours in the scan slices, which is a tedious, time-consuming, and error prone task that requires medical expertise and that may yield significant intra- and inter-observer variability. Consequently, manual lesions delineation for the purpose of obtaining volumetric measurements is seldom performed in the clinic today.

Segmentation is the task of computer-based delineation of lesions in a radiological image. Segmentation is commonly used to compute individual and overall lesion volume and to evaluate disease progression, as it yields accurate and reproducible volume measurements. Many segmentation methods for a variety of structures, including lesions, have been developed over the past three decades.

### SUMMARY OF THE INVENTION

A broad aspect of the invention relates to automation of radiological follow-up in CT and/or MRI images.

One aspect of some embodiments of the invention relates to computer implemented group-wise 3D registration of two or more medical images of a same modality followed by parallel lesion detection in the registered images. According to various exemplary embodiments of the invention the volumetric digital images are CT or MRI or PET or SPECT. In some exemplary embodiments of the invention, each lesion in the current volumetric image is defined as new, existing or disappeared relative to a previous image.

Another aspect of some embodiments of the invention relates to group-wise 3D registration of two or more medical images of a same modality arranged sequentially and computer mediated identification of a new lesion in one of said images relative to one or more previous images.

A third aspect of some embodiments of the invention relates to group-wise 3D registration of two or more medical images of a same modality and computer mediated identification of a lesion which is absent in one of the images relative to at least one previous image.

A fourth aspect of some embodiments of the invention relates to group-wise 3D registration of two or more medical images of a same modality and computer mediated identification of a lesion which is present in one of the images and also present in at least one previous image. In some embodiments, the computer determines a change in size of the lesion from one image to another. Alternatively or additionally, the computer determines a magnitude of the change in size (i.e. growth or shrinkage).

It will be appreciated that the various aspects described above relate to solution of technical problems associated with monitoring disease progression and/or treatment efficacy objectively.

Alternatively or additionally, it will be appreciated that the various aspects described above relate to solution of technical problems related to standardization of analysis in radiological follow up.

In some exemplary embodiments of the invention there is provided a computer implemented method including: (a) receiving at a data processor two or more digital data files representing medical images of a same modality; (b) performing group-wise 3D registration of the digital data files representing medical images of a same modality; and (c) parallel lesion detection on the digital data files representing the medical images. In some embodiments, the number of medical images is 2. Alternatively or additionally, in some embodiments is 3 to 10. Alternatively or additionally, in some embodiments the lesion detection relies on one or more algorithms selected from the group consisting of baseline pairwise analysis; sequential pairwise analysis, and simultaneous n-way analysis. Alternatively or additionally, in some embodiments the 3D registration relies on NiftyReg and/or GLIRT (Group-wise and Longitudinal Image Registration Toolbox) libraries. Alternatively or additionally, in some embodiments the method includes using a data processor to assign each lesion identified in the lesion detection to a category selected from the group consisting of existing, disappearing and new. Alternatively or additionally, in some embodiments the method includes presenting at least one of the medical images in a graphical user interface (GUI) which indicates for each lesion which of the categories it belongs to. Alternatively or additionally, in some embodiments the method includes using a data processor to generate a report indicating a total lesions volume for at least one of the medical images. Alternatively or additionally, in some embodiments the report indicates a change in lesion volume for at least one images relative to one or more previous images.

In some exemplary embodiments of the invention there is provided a computer implemented method including: (a) receiving at a data processor two or more digital data files representing medical images of a same modality; (b) performing group-wise 3D registration of the two or more digital data files representing the medical images; and (c) identifying one or more new lesions in one of the images relative to one or more previous images using a data processor. In some embodiments, the number of medical images is 2. Alternatively or additionally, in some embodiments the number of medical images is 3 to 10. Alternatively or additionally, in some embodiments the identifying relies on an algorithm selected from the group consisting of model-based, machine learning or deep learning methods such as Convolutional Neural Network (CNN) that performs patch classification. Alternatively or additionally, in some embodiments the method includes detecting lesion changes in at least one of the medical images wherein the detecting relies on one or more algorithms selected from the group consisting of baseline pairwise analysis; sequential pairwise analysis, simultaneous group-wise analysis. Alternatively or additionally, in some embodiments the 3D group-wise registration relies upon NiftyReg and/or GLIRT (Group-wise and Longitudinal Image Registration Toolbox) libraries. Alternatively or additionally, in some embodiments the method includes presenting the medical images in a graphical user interface. Alternatively or additionally, in some embodiments the method includes using a data processor to generate a report indicating number of new lesions in at least one of the medical images.

In some exemplary embodiments of the invention there is provided a computer implemented method including: (a) receiving at a data processor two or more digital data files representing medical images of a same modality; (b) performing group-wise 3D registration of the digital data files representing the medical images; and (c) identifying one or more lesions which is absent in one of the images relative to at least one previous image. In some embodiments, number of medical images is 2. Alternatively or additionally, in some embodiments the number of medical images is 3 to 10. Alternatively or additionally, in some embodiments the identifying relies on an algorithm selected from the group consisting of model-based, machine learning, and deep learning methods, such as Convolutional Neural Network (CNN) that performs patch classification. Alternatively or additionally, in some embodiments the method includes detecting lesions in each of the medical images wherein the lesion detection relies on one or more algorithms selected from the group consisting of baseline pairwise analysis; sequential pairwise analysis and simultaneous group-wise analysis. Alternatively or additionally, in some embodiments the 3D group-wise registration relies upon NiftyReg and/or GLIRT (Group-wise and Longitudinal Image Registration Toolbox) libraries. Alternatively or additionally, in some embodiments the method includes presenting the medical images in a graphical user interface which indicates absent lesions graphically. Alternatively or additionally, in some embodiments the method includes using a data processor to generate a report indicating number of absent lesions in at least one medical image.

In some exemplary embodiments of the invention there is provided a computer implemented method including: (a) receiving at a data processor two or more digital data files representing medical images of a same modality; (b) performing group-wise 3D registration of the digital data files representing the medical images; and (c) identifying one or more lesions which is present in one of the medical images and also present in at least one previous image. In some embodiments, the number of medical images is 2. Alternatively or additionally, in some embodiments the number of medical images is 3 to 10. Alternatively or additionally, in some embodiments the identifying relies on model-based, machine learning and/or deep learning classifier. Alternatively or additionally, in some embodiments the method includes detecting lesions in each of the medical images, wherein the lesion changes detection relies on one or more algorithms selected from the group consisting of baseline pairwise analysis; sequential pairwise analysis, simultaneous group-wise analysis. Alternatively or additionally, in some embodiments the 3d registration employs NiftyReg and/or GLIRT (Group-wise and Longitudinal Image Registration Toolbox) libraries. Alternatively or additionally, in some embodiments the method includes presenting at least one of the medical images in a graphical user interface which indicates each lesion which is present in one of the images and also present in at least one previous image graphically. Alternatively or additionally, in some embodiments the method includes using a data processor to generate a report indicating a change in volume for each lesion which is present in one of the images and also present in at least one previous image. Alternatively or additionally, in some embodiments the method includes visually representing a change in volume for each lesion which is present in one of the images and also present in at least one previous image.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office. Thus, any recitation that an embodiment “includes” or “comprises” a feature is a specific statement that sub embodiments “consist essentially of” and/or “consist of” the recited feature.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

The phrase “adapted to” as used in this specification and the accompanying claims imposes additional structural limitations on a previously recited component.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

For purposes of this specification and the accompanying claims, the term “image” or “medical image” indicates a volumetric medical image comprising a stack of parallel planar (2D) images, called scan slices or slices. Slices are typically gray scale representations. Images are acquired with a specific modality and scanning protocol at a specific resolution (xy in-plane, z distance between slices, slice thickness). Scan modalities include, but are not limited to, CT, MRI, fMRI, PET, SPECT and/or hybrid modalities including but not limited to PET/CT and SPECT/CT. Scan protocols include, but are not limited to, contrast/non-contrast, phase, and modality-specific protocols, e.g. MRI T1, T2, and FLAIR Images have a time stamp which indicates when they were acquired. Radiologists typically refer to a volumetric medical image as a “scan”.

For purposes of this specification and the accompanying claims, the term “lesion” includes any abnormality considered a radiological finding. “Lesion” includes, but is not limited to, primary tumors, metastases, cysts, abscesses and hematomas.

For purposes of this specification and the accompanying claims, the term “group-wise” indicates processing of two or more images. According to various exemplary embodiments of the invention group-wise processing is applied to registration and/or lesion detection and/or segmentation and/or lesion analysis.

For purposes of this specification and the accompanying claims, the term “Parallel lesion detection” includes both:

1) independent, standalone detection in a single image and

2) simultaneous, coupled detection in two or more images.

For purposes of this specification and the accompanying claims, the term “registration” indicates alignment of two of more images so that they have the same coordinate system using 3D rigid and deformable registration (Group-wise image registration based on a total correlation dissimilarity measure for quantitative MRI and dynamic imaging data. Guyader et al, Nature Scientific Reports, 2018.)

Implementation of the method and system according to embodiments of the invention involves performing or completing selected tasks or steps manually, automatically, or a combination thereof. Moreover, according to actual instrumentation and equipment of exemplary embodiments of methods, apparatus and systems of the invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is a simplified block diagram of a platform for automatic radiological follow-up according to some exemplary embodiments of the invention;

FIG. 2 is a simplified flow diagram of a method according to some exemplary embodiments of the invention;

FIG. 3 is a simplified flow diagram of a method according to some exemplary embodiments of the invention;

FIG. 4 is a simplified flow diagram of a method according to some exemplary embodiments of the invention;

FIG. 5 is a simplified flow diagram of a method according to some exemplary embodiments of the invention;

FIG. 6a depicts liver lesion(s) in a baseline CT slice with delineated existing lesion (red);

FIG. 6b is a follow-up liver CT slice (closest one) from the same subject as in 6a;

FIG. 6c is the CT slice of 6b with delineations of existing lesions (red) and new lesions (green) produced by an exemplary embodiment of the invention;

FIG. 7 depicts exemplary CT slices of brain with baseline in panel (a) and follow-up in panel (b) with existing tumor segmentation (red), and two new metastases (yellow) presented with an exemplary user interface showing longitudinal study statistics (left bottom) which list the measures for existing, new and disappeared lesions volumes and volume differences (in cc and %) a s well as interface buttons (lower right) that allow visual exploration of the scans and the delineations produced by an exemplary embodiment of the invention for validation;

FIG. 8 illustrates examples of input and output of two radiological lesions follow-up tasks: column (a): liver tumors follow-up in CT studies and column (b): brain tumors follow-up in MRI studies; in each column: the uppermost image is a representative baseline scan slice with lesion segmentation superimposed on it in red; the middle image is the corresponding follow-up scan slice and the bottom image is the same follow up scan slice with tumors identified by an exemplary embodiment of the invention superimposed on it in red.

### DETAILED DESCRIPTION OF EMBODIMENTS

Embodiments of the invention relate to methods for automation of radiological follow up as well as user interfaces that present findings graphically.

Specifically, some embodiments of the invention can be used to determine for each tumor in a patient whether it is new, previously existing or has disappeared. In some embodiments, change in characteristics of previously existing tumors is automatically determined (i.e. amount of growth/shrinkage). Alternatively or additionally, in some embodiments a quantitative lesion and/or lesion changes report is generated automatically.

The principles and operation of a methods and/or graphical user interfaces (GUIs) according to exemplary embodiments of the invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

Overview

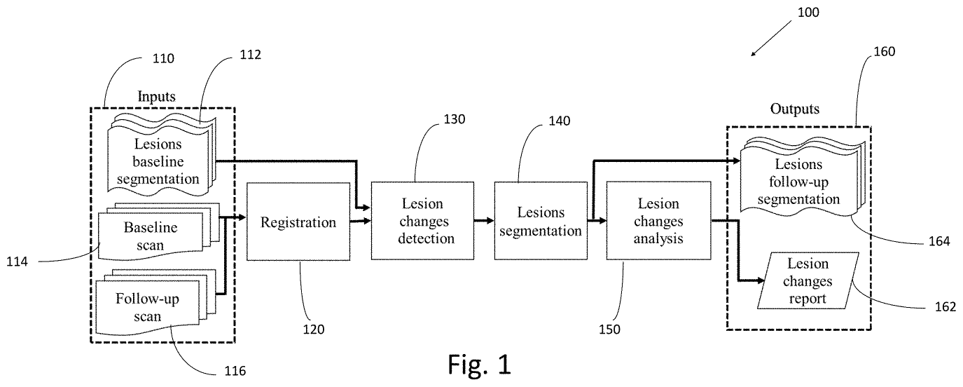

FIG. 1 is a simplified block diagram of a platform, indicated generally as 100, for automatic radiological follow-up according to some exemplary embodiments of the invention.

In the depicted embodiment, inputs 110 include a baseline scan 114 and one or more follow up scans 116. In some embodiments, baseline scan 114 is provided with a manual lesions segmentation 112 performed by a radiologist. In other exemplary embodiments of the invention, baseline segmentation 112 is performed by a computer. In either case segmentation 112 is provided as an input 110.

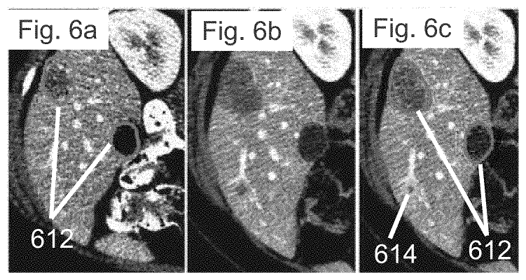

Scans 114 and 116 are then registered 120 with respect to one another. The registered scans are then subject to lesion changes detection 130 followed by lesion segmentation 140 in follow up scan 116. Output 160 includes follow up segmentation 164 (see, for example FIG. 6c).

In the depicted embodiment, segmentation 140 is followed by lesion changes analysis 150 which optionally produces lesion changes report 162 and/or contributes to the way lesions are presented in segmentation 164.

### First Exemplary Method

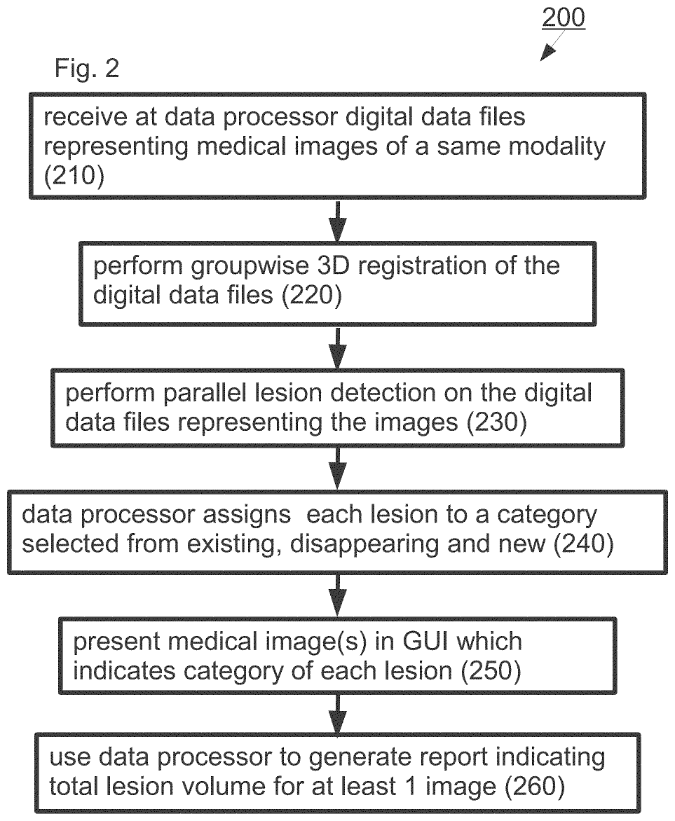

FIG. 2 is a simplified flow diagram of a method for computer implemented radiological follow-up, indicated generally as 200, according to some exemplary embodiments of the invention.

Depicted computer implemented method 200 includes receiving 210 at a data processor two or more digital data files representing medical images of a same modality. In some exemplary embodiments of the invention, the medical images represent a longitudinal study in a single patient or a portion thereof. Suitable modalities and scanning protocols include, but are not limited to, CT and MRI. In some embodiments, different images have different resolutions. These modality and resolutions factors apply also to other methods set forth hereinbelow.

Depicted method 200 includes performing 220 group-wise 3D registration of the digital data files representing the medical images of a same modality and performing 230 parallel lesion detection in the multiple images. Although lesion detection in the images is described for ease of comprehension, the data processor actually analyzes (i.e. “looks”) at the digital data encoding each image. Relying on a data processor to detect lesions by analyzing the digital data contributes to an increase in reliability and/or objectivity of the analysis. In some embodiments, the number of medical images is 2. In other exemplary embodiments of the invention, the number of medical images is 3, 4, 5, 6, 7, 8, 9, 10 or more.

According to various exemplary embodiments of the invention, lesion detection 230 relies on baseline pairwise analysis and/or sequential pairwise analysis and/or simultaneous group-wise analysis. In some embodiments, the 3D registration is performed by standard methods, e.g., NiftyReg and/or GLIRT (Group-wise and Longitudinal Image Registration Toolbox) libraries.

Alternatively or additionally, in some embodiments method 200 includes using a data processor to assign 240 each lesion identified in lesion detection 230 to a category selected from the group consisting of existing, disappeared and new. Category assignment in this method, and other methods described hereinbelow relies on a combination of the coordinates of pixels in the lesion and the time stamp associated with the image.

Alternatively or additionally, in some embodiments method 200 includes presenting 250 at least one of the medical images in a graphical user interface (GUI) which indicates for each lesion which of the categories it belongs to. In some exemplary embodiments of the invention, indication is by color coding. For example, by outlining or filling existing lesions in orange; new lesions in red and disappeared lesions in yellow.

Alternatively or additionally, in some embodiments method 200 includes using 260 a data processor to generate a report indicating a total lesions volume for at least one of the medical images. In some embodiments, the report indicates a change in lesion burden for each image relative to one or more previous images.

Second Exemplary Method

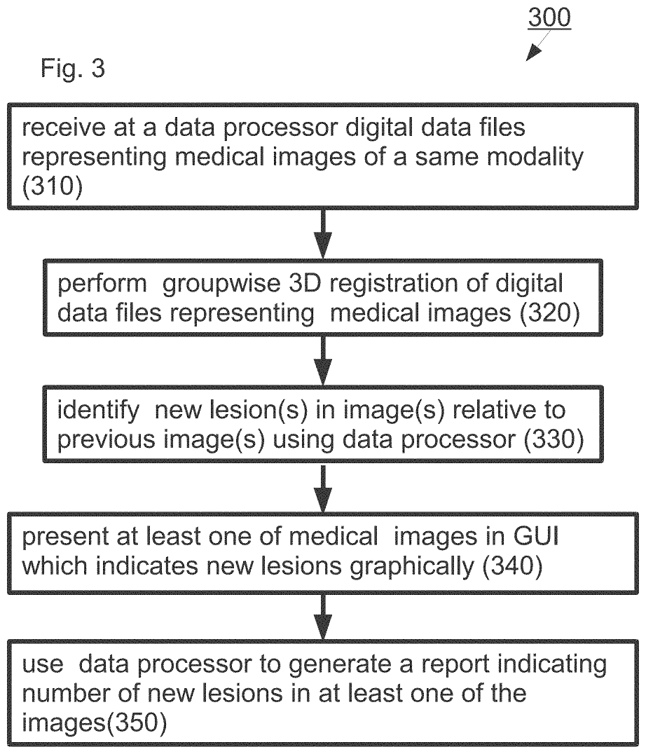

FIG. 3 is a simplified flow diagram of a method for computer implemented radiological follow-up, indicated generally as 300, according to some exemplary embodiments of the invention.

Depicted computer implemented method 300 includes receiving 310 two or more digital data files representing medical images of a same modality.

In the depicted embodiment, method 300 includes performing 320 group-wise 3D registration of said two or more digital data files representing the medical images and identifying 330 one or more new lesions in one of said images relative to one or more previous images using a data processor. In some embodiments, the number of medical images is 2. In other exemplary embodiments of the invention, the number of medical images is 3, 4, 5, 6, 7, 8, 9, 10 or more.

Alternatively or additionally, in some embodiments identifying 330 relies on a model-based, machine learning or deep learning methods. One example of such a method is Convolutional Neural Network (CNN) that performs patch classification.

Alternatively or additionally, in some embodiments method 300 includes detecting lesion changes in at least one of the medical images. According to various exemplary embodiments of the invention, the lesion detection relies on one or more algorithms selected from the group consisting of baseline pairwise analysis; sequential pairwise analysis, simultaneous n-way analysis. Alternatively or additionally, in some embodiments the 3D group-wise registration is performed with standard methods, e.g., NiftyReg, GLIRT (Group-wise and Longitudinal Image Registration Toolbox) libraries.

Alternatively or additionally, in some embodiments method 300 includes presenting 340 at least one of the medical images in a graphical user interface (GUI) which indicates new lesions graphically.

Alternatively or additionally, in some embodiments method 300 includes using a data processor to generate 350 a report indicating number of new lesions in at least one of the medical images. Optionally, the report includes volume of new lesions.

Third Exemplary Method

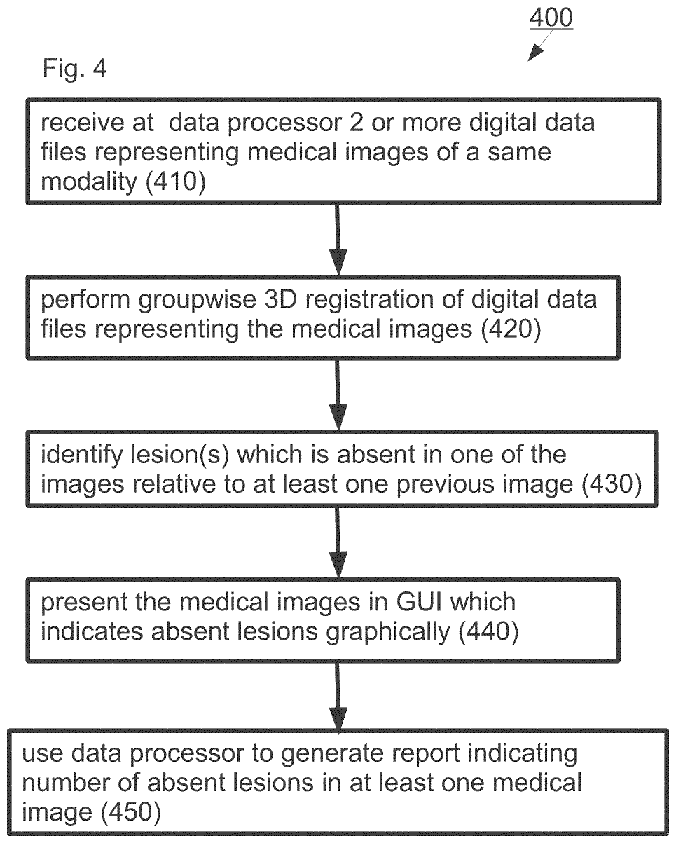

FIG. 4 is a simplified flow diagram of a method for computer implemented radiological follow-up, indicated generally as 400, according to some exemplary embodiments of the invention.

Depicted exemplary method 400 includes receiving 410 two or more digital data files representing medical images of a same modality.

In the depicted embodiment, method 400 includes performing 420 group-wise 3D registration of said digital data files representing said medical images and identifying 430 one or more lesions which is absent in one of said images relative to at least one previous image. In some embodiments, the number of medical images is 2. In other exemplary embodiments of the invention, the number of medical images is 3, 4, 5, 6, 7, 8, 9, 10 or more.

Alternatively or additionally, in some embodiments identifying 430 relies on model-based, machine learning, and deep learning methods, e.g. Convolutional Neural Network (CNN) that performs patch classification. Alternatively or additionally, in some embodiments the 3D group-wise registration 420 relies upon NiftyReg and/or GLIRT (Group-wise and Longitudinal Image Registration Toolbox) libraries.

Alternatively or additionally, in some embodiments method 400 includes detecting lesions in each of said medical images. According to various exemplary embodiments of the invention the lesion detection relies on baseline pairwise analysis and/or sequential pairwise analysis and/or simultaneous n-way analysis.

Alternatively or additionally, in some embodiments method 400 includes presenting 440 presenting the medical images in a graphical user interface (GUI) which indicates absent lesions graphically.

Alternatively or additionally, in some embodiments method 400 includes using a data processor to generate 450 using a data processor to generate a report indicating number of absent lesions in at least one medical image.

Fourth Exemplary Method

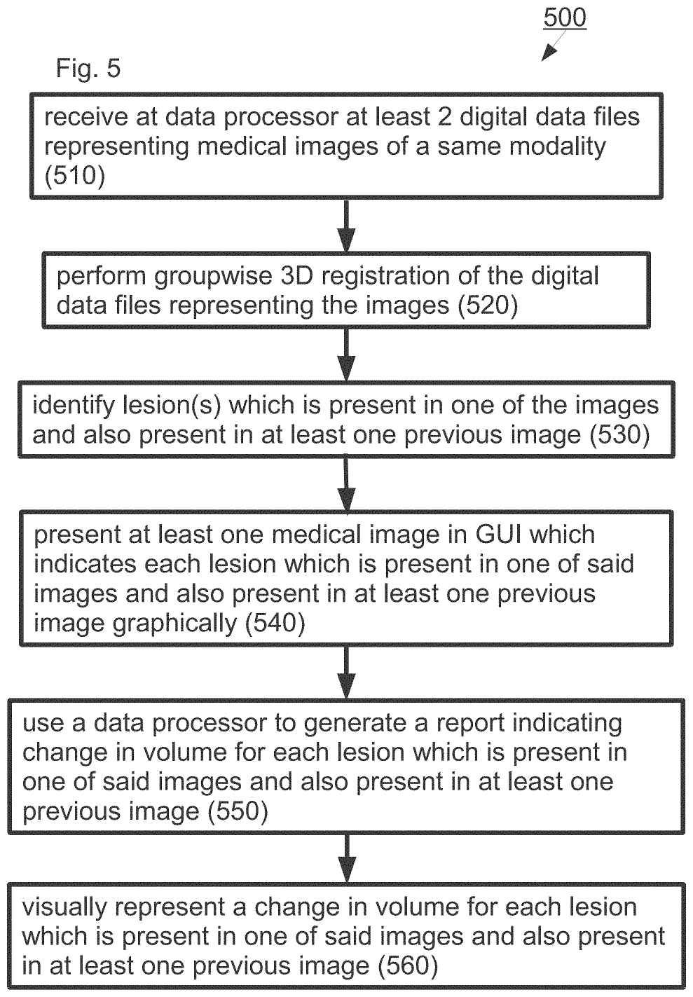

FIG. 5 is a simplified flow diagram of a method for computer implemented radiological follow-up, indicated generally as 500, according to some exemplary embodiments of the invention.

In the depicted embodiment, method 500 includes receiving 510 at a data processor two or more digital data files representing medical images of a same modality. In some embodiments, method 500 includes performing 520 group-wise 3D registration of digital data files representing the medical images and identifying 530 one or more lesions which is present in one of the medical images and also present in at least one previous image. In some embodiments, the number of medical images is 2. In other exemplary embodiments of the invention, the number of medical images is 3, 4, 5, 6, 7, 8, 9, 10 or more.

In some embodiments, identifying 530 relies on model-based, machine learning or deep learning classifier such as, for example, a Convolutional Neural Network (CNN) that performs patch classification.

Alternatively or additionally, in some embodiments method 500 includes detecting lesions in each of the multiple sets of temporally labelled volumetric digital images. According to various exemplary embodiments of the invention the lesion detection relies on baseline pairwise analysis and/or sequential pairwise analysis and/or simultaneous n-way analysis. Alternatively or additionally, in some embodiments the 3D registration employs NiftyReg and/or GLIRT (Group-wise and Longitudinal Image Registration Toolbox) libraries.

In some exemplary embodiments of the invention, method 500 includes presenting 540 at least one of the medical images in a graphical user interface (GUI) which indicates each lesion which is present in one of said images and also present in at least one previous image graphically (e.g. by filling or outlining in a contrasting color). Alternatively or additionally, in some exemplary embodiments of the invention, method 500 includes using a data processor to generate 550 a data processor to generate a report indicating a change in volume for each lesion which is present in one of said images and also present in at least one previous image. In some exemplary embodiments of the invention, method 500 includes visually representing 560 a change in volume for each lesion which is present in one of said images and also present in at least one previous image.

Exemplary Enhanced Images

FIG. 6a depicts liver tumor(s) in a baseline CT slice with delineated existing tumors (612; red).

FIG. 6b is a follow-up liver CT slice (closest one) from the same subject as in 6a.

FIG. 6c is the CT slice of 6b with segmentations of previously existing tumors (612; red) and new metastasis (614; green) produced by an exemplary embodiment of the invention.

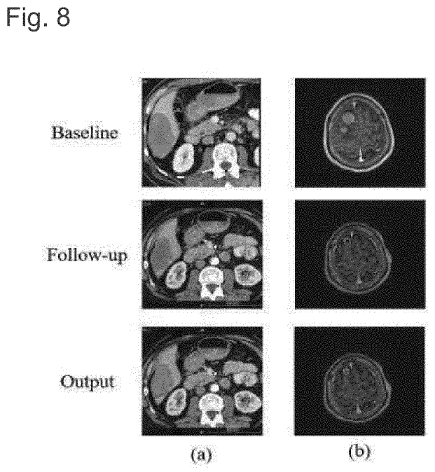

FIG. 8 illustrates examples of input and output of two radiological lesions follow-up tasks: (a) liver tumors follow up in CT studies and (b) brain tumors follow up in MRI studies. In each column:

the uppermost image is a representative baseline scan slice with lesion segmentation superimposed on it in red;

the middle image is corresponding follow up scan slice; and

the bottom image is the same follow up scan slice with tumors identified by an exemplary embodiment of the invention superimposed on it in red.

Exemplary Registration Methodologies

The concept of group-wise 3D registration, which is also called n-wise registration, is well understood by those of ordinary skill in the art. See, for example:

1. Group-wise image registration based on a total correlation dissimilarity measure for quantitative MRI and dynamic imaging data. Guyader et al, Nature Scientific Reports, 2018;

2. Metz, C., Klein, S., Schaap, M., van Walsum, T. & Niessen, W. Nonrigid registration of dynamic medical imaging data using nD+t B-splines and a group-wise optimization approach. Med Image Anal 15, 238-249 (2011);

3. Huizinga, W. et al. PCA-based group-wise image registration for quantitative MRI. Med Image Anal 29, 65-78 (2016);

Each of which is fully incorporated herein by reference

For the evaluation of the quality of the registration see:

4. Wachinger, C. & Navab, N. Simultaneous registration of multiple images: similarity metrics and efficient optimization. IEEE Trans Pattern Anal 35, 1-14 (2012); which is fully incorporated herein by reference.

Exemplary Segmentation Methodologies

According to various exemplary embodiments of the invention the analysis includes one or more follow-up sets of images acquired in patient scans in a longitudinal study. In some embodiments, this allows the analysis of longitudinal studies with several images acquired at subsequent time points. Let L-STUDY=<S₁, . . . , Sₙ> be a longitudinal study of the patient consisting of n scans taken at subsequent times t₁, . . . , tₙ where S₁ is the first scan acquired at time t₁. The output is, for each time point a set of lesions segmentations, L, ={(lᵢⱼ,cᵢⱼ)} where lᵢⱼ is the segmentation of lesion j at time i and cᵢⱼ is the lesion type (existing, new, disappeared). The lesions follow-up segmentation is the set of all the individual segmentations, L={L₁, . . . Lₙ}.

According to various exemplary embodiments of the invention the baseline scan is the first scan S₁ or any one of the following scans. In this setup, the baseline scan, denoted by B, is the reference scan to which the other scans will be compared.

There are at least three possible approaches for longitudinal studies analysis:

(A) Baseline pairwise analysis: each pair of scans (B,Sᵢ) is analyzed individually using the core method (FIG. 1) with or without baseline segmentation. The pairwise lesion changes analyses and lesions follow-up segmentations Lᵢ are then combined with a new module (Longitudinal lesion changes analysis) to produce a longitudinal lesion changes report. The lesions follow-up segmentation is the set of all individual segmentations.
(B) Sequential pairwise analysis: each pair of subsequent scans (Sᵢ,Sᵢ₊₁) is analyzed individually using the core method (FIG. 1) to produce a set of lesion follow-up segmentations Lᵢ₊₁. This set is used as the lesions segmentation baseline for the analysis of the pair (Sᵢ₊₁, Sᵢ₊₂) in a cascading fashion. The initial pair (S₁,S₂) is analyzed individually using the core method (FIG. 1) with or without baseline segmentation. The sequential pairwise lesion changes analyses and lesions follow-up segmentations Lᵢ are then combined with a new module (Longitudinal lesion changes analysis) to produce a longitudinal lesion changes report. The lesions follow-up segmentation is the set of all individual segmentations.
(C) Simultaneous group-wise analysis: all scans are simultaneously registered to the baseline scan and the analysis is performed jointly. This scenario requires the joint, group-wise (n-way) registration, lesion changes detection, lesions segmentations, and lesion changes analysis. The scans in the longitudinal patient L-STUDY become, after registration, a multidimensional scans matrix SM in which each voxel in the baseline scan B is associated with an n-dimensional voxel intensity vector consisting of the voxel gray values of the original scans. The lesions changes detection, lesion segmentations, and lesion changes analysis are then performed with the voxel intensity vectors instead of the individual voxel intensities of the baseline and the follow-up scans.

In some embodiments, the scan slices are first jointly registered, either by pairwise (2-way) registration with the core (FIG. 1) registration module 120, or by group-wise (n-way) registration with existing methods (e.g., NiftyReg, GLIRT (Group-wise and Longitudinal Image Registration Toolbox) libraries.). Once the scans are registered, their sizes and resolutions are normalized so that the number and location of voxels in each scan is identical to that of the baseline. The result is a multi-dimensional matrix SM consisting of n-dimensional voxel intensity vectors consisting of the voxel gray values of the original scans. The voxel vectors have the same location and spatial organization as the baseline scan.

Exemplary Temporal Comparison Methodologies

The simultaneous lesion changes detection then inputs the matrix SM and identifies the three types of lesion changes: changes in existing lesions, disappearance of existing lesions, and appearance of new lesions. Note that these changes can occur at any given time tᵢ and not only at the baseline scan time t₁. The characteristics of the changes are as described in the Lesion changes detection description. The detection is performed for each type of change with a model-based or a machine learning algorithm, or with a Convolutional Neural Network (CNN) that performs ROI patch classification. The outputs are the ROIs of all the lesions in SM.

The simultaneous lesion segmentation inputs the existing and new lesions ROIs and the matrix SM and produces segmentations set L={L₁, . . . Lₙ} where Lᵢ={(lᵢⱼ,cᵢⱼ)} where lᵢⱼ is the segmentation of lesion j at time i and cᵢⱼ is the lesion type (existing, new). The segmentations can be generated in sequential order as described in the baseline and sequential pairwise analysis (segmentation) or by performing group-wise longitudinal segmentation with a model-based or a machine learning algorithm, or with or Convolutional Neural Network (CNN) that performs the classification.

The simultaneous lesion changes analysis inputs the segmentations set and produces the longitudinal changes analysis report with the same method as the sequential pairwise analysis (Longitudinal lesion changes analysis).

Exemplary Change Analysis Methodology

In some embodiments, a lesion changes analysis module inputs the lesions segmentations and produces a lesion changes report. There are at least two possibilities:
pairwise changes analysis and
longitudinal changes analysis (the former is a special case of the later).

Pairwise Lesion Changes Analysis

In this embodiment lesion changes analysis consists of four parts:

a) Volumetric and linear measurements table (Table 1).

b) Volumetric and linear measurements summary table (Table 2).

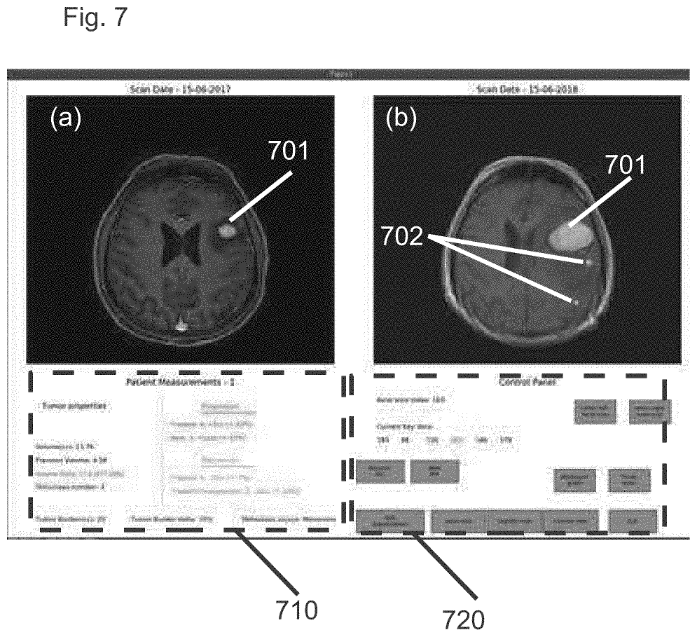

c) Visual summary: key frames with overlaid annotations (FIG. 7).

d) RECIST 1.1 measurements table—to be determined according to the current standard.

RECIST measurements are linear measurements. They are a subset of the linear measurements, e.g. the three largest lesions as opposed to all lesions. (Eisenhauer E, Therasse P, Bogaerts J, Schwartz L H, Sargent D, Ford R, Dancey J, Arbuck S, Gwyther S, Mooney M, Rubinstein L. New response evaluation criteria in solid tumours:revised RECIST guideline (Ver 1.1). European Journal of Cancer. vol. 45(2) pp. 228-47, 2009.)

TABLE 1
Volumetric and linear measurements table: per lesion. The lesion type is one of:
existing, new, disappeared. The lesion location is the top and bottom slice numbers
where the lesion appears in the baseline and follow-up scans. The following columns
are the volumetric and the linear measurements in cc, mm, and %.

| | LESION | | VOLUMETRIC | | | | LINEAR | | | |
|---|---|---|---|---|---|---|---|---|---|---|
| Lesion | Lesion | Lesion | Baseline | Follow-up | Diff | Diff | Baseline | Follow-up | Diff | Diff |
| # | type | location | cc | cc | cc | % | cc | mm | mm | mm % |

1
2
. . .
n

TABLE 2
Volumetric and linear measurements table: per lesion. The lesion type is one of:
existing, new, disappeared. The lesion location is the top and bottom slice numbers
where the lesion appears in the baseline and follow-up scans. The following columns
are the volumetric and the linear measurements in cc, mm, and %.

| | | VOLUMETRIC | | | | LINEAR | | | |
|---|---|---|---|---|---|---|---|---|---|
| | # of | Baseline | Follow-up | Diff | Diff | Baseline | Follow-up | Diff | Diff |
| Summary | lesions | cc | cc | cc | % | mm | mm | mm | mm % |

Existing
New
Disappeared
Total tumor
volume

FIG. 7 is an illustration of the lesions changes analysis summary on brain lesions: baseline (a) and follow-up (b) key axial slices after registration (number 163) showing the existing tumor segmentation (701; red), and two new metastases (702; yellow). The study statistics (710; left bottom) list the measures for existing, new and disappeared lesions volumes and volume differences (in cc and %). The radiologist can visually explore the scans for validation (720; lower right buttons).

Exemplary Reporting Modalities

According to various exemplary embodiments of the invention a report is generated on the lesions present in one or more images and/or their changes relative to one or more other images.

Lesion changes refer to the difference in the appearance of lesions in one image with respect to one or more other images in a temporal sequence. Changes can be of a single lesion or multiple lesions, and on pairs of images or on sequences of three or more images. Lesion changes include changes in morphology (shape and size), intensity (gray value mean, standard deviation, histogram) and texture. The differences also include topology changes, e.g. a lesion splitting into two or two lesions merging into one lesion in a subsequent image. In some embodiments, lesion changes are quantified. In other exemplary embodiments of the invention, the changes are qualitative.

### Single Lesion Changes, Pair of Images Qualitative

TABLE 3
Single lesion changes in two scans: lesion changes
between two scans are one of four types:

| CHANGE | | | | Observations/ |
|---|---|---|---|---|
| TYPE | Baseline | Follow-up | Interpretation | other terms |
| No lesion | 0 | 0 | Absent in both scans | Healthy tissue |
| | 0 | 0 | Undetected in | Lesion is non-specific |
| | | | both scans | or too small |
| | | | | to characterize |
| | | | | in both scans |
| New | 0 | 1 | Absent in baseline | Lesion appeared in |
| | | | Present in follow-up | follow-up scan |
| Disappeared | 1 | 0 | Present in baseline | Lesion vanished or became |
| | | | Absent in follow-up | non-specific or too small |
| Existing | 1 | 1 | Present in both scans | Lesion is persistent |
| | | | Persistent lesion | |

Legend: 0: lesion absent in the ground-truth; 1; lesion present in the ground-truth.

Synonym terms of disappeared are missing, absent, vanished. Synonym term of existing is recurrent.
Single Lesion Changes, Sequence of More than Two Images Scans

TABLE 4
Single lesion changes in three or more scans: lesion changes in a sequence
of scans S = <S₁, . . . , Sᵢ, . . . , Sₖ> are one of five types:

| CHANGE | First scan | | | | Last scan | |
|---|---|---|---|---|---|---|
| TYPE | S₁ | . . . | Sᵢ | . . . | Sₖ | Interpretation |
| No lesion | 0 | 0 | 0 | 0 | 0 | Absent in all scans |
| | 0 | 0 | 0 | 0 | 0 | Undetected in all scans |
| New | 0 | 0 | 0 | 0 | 1 | Absent in all but last scan |
| | | | | | | Present in last scan |
| Disappeared | 1 | 0 | 0 | 0 | 0 | Present in first scan |
| | | | | | | Absent in all subsequent scans |
| | 1 | 1 | 1 | 1 | 0 | Present in all but last scan |
| | | | | | | Absent in last scan |
| Existing | 1 | 1 | 1 | 1 | 1 | Present in all scans |
| | | | | | | Persistent lesion |

| | | |
|---|---|---|
| Mixed | Any series of 0 and 1 not above | Break into subsequences |

Mixed sequences: sequences that are not 0*, 0*1, 10*, 1*0 are broken into maximal subsequences of these strings (the string 0* is a string of any number of 0s). For example, the lesion changes sequence is 0001111001 becomes 3 sequences: 0001, 1110, 01→ new, disappeared, new.
Lesion time of first detection/appearance: the time when a lesion becomes new.

It is expected that during the life of this patent many volumetric medical imaging technologies will be developed and the scope of the invention is intended to include all such new technologies a priori.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Specifically, a variety of numerical indicators have been utilized. It should be understood that these numerical indicators could vary even further based upon a variety of engineering principles, materials, intended use and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims.

Each recitation of an embodiment of the invention that includes a specific feature, part, component, module or process is an explicit statement that additional embodiments of the invention not including the recited feature, part, component, module or process exist.

Alternatively or additionally, various exemplary embodiments of the invention exclude any specific feature, part, component, module, process or element which is not specifically disclosed herein.

Specifically, the invention has been described in the context of volumetric medical images but might also be used in the context of aerial or satellite photographs.

All publications, references, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

We claim:

1. A computer implemented method comprising:
(a) receiving at a data processor two or more digital data files representing medical images of a same modality;
(b) performing group-wise 3D registration of said digital data files representing medical images of a same modality; and
(c) parallel lesion detection and analysis on said digital data files representing said medical images.

2. A method according to claim 1, wherein the number of medical images is 2.

3. A method according to claim 1, wherein the number of medical images is 3 to 10.

4. A method according to claim 1, wherein said lesion detection and analysis relies on one or more algorithms selected from the group consisting of baseline pairwise detection and analysis; sequential pairwise detection and analysis, and simultaneous n-way detection and analysis.

5. A method according to claim 1, wherein said 3D registration relies on NiftyReg and/or GLIRT (Group-wise and Longitudinal Image Registration Toolbox) libraries.

6. A method according to claim 1, comprising using a data processor to assign each lesion identified in said lesion detection to a category selected from the group consisting of existing, disappearing and new.

7. A method according to claim 6, comprising presenting at least one of said medical images in a graphical user interface (GUI) which indicates for each lesion which of said categories it belongs to.

8. A method according to claim 1, comprising using a data processor to generate a report indicating a total lesions volume for at least one of said medical images.

9. A method according to claim 8, wherein said report indicates a change in lesion volume for at least one images relative to one or more previous images.

10. A computer implemented method comprising:
(a) receiving at a data processor two or more digital data files representing medical images of a same modality;
(b) performing group-wise 3D registration of said two or more digital data files representing said medical images; and
(c) identifying one or more new lesions in one of said images relative to one or more previous images using a data processor.

11. A method according to claim 10, wherein the number of medical images is 2.

12. A method according to claim 10, wherein the number of medical images is 3 to 10.

13. A method according to claim 10, wherein said identifying relies on an algorithm selected from the group consisting of model-based, machine learning or deep learning methods such as Convolutional Neural Network (CNN) that performs patch classification.

14. A method according to claim 10, comprising detecting lesion changes in at least one of said medical images wherein said detecting relies on one or more algorithms selected from the group consisting of baseline pairwise analysis; sequential pairwise analysis, simultaneous group-wise analysis.

15. A method according to claim 10, wherein said 3D group-wise registration relies upon NiftyReg and/or GLIRT (Group-wise and Longitudinal Image Registration Toolbox) libraries.

16. A method according to claim 10, comprising presenting said medical images in a graphical user interface which indicates new lesions graphically.

17. A method according to claim 10, comprising using a data processor to generate a report indicating number of new lesions in at least one of said medical images.

18. A computer implemented method comprising:
(a) receiving at a data processor two or more digital data files representing medical images of a same modality;
(b) performing group-wise 3D registration of said digital data files representing said medical images; and
(c) identifying one or more lesions which is absent in one of said images relative to at least one previous image.

19. A method according to claim 18, wherein the number of medical images is 2.

20. A method according to claim 18, wherein the number of medical images is 3 to 10.

21. A method according to claim 18, wherein said identifying relies on an algorithm selected from the group consisting of model-based, machine learning, and deep learning methods, such as Convolutional Neural Network (CNN) that performs patch classification.

22. A method according to claim 18, comprising detecting lesions in each of said medical images wherein said lesion detection relies on one or more algorithms selected from the group consisting of baseline pairwise analysis; sequential pairwise analysis and simultaneous group-wise analysis.

23. A method according to claim 18, wherein said 3D group-wise registration relies upon NiftyReg and/or GLIRT (Group-wise and Longitudinal Image Registration Toolbox) libraries.

24. A method according to claim 18, comprising presenting said medical images in a graphical user interface which indicates absent lesions graphically.

25. A method according to claim 18, comprising using a data processor to generate a report indicating number of absent lesions in at least one medical image.

26. A computer implemented method comprising:
(a) receiving at a data processor two or more digital data files representing medical images of a same modality;
(b) performing group-wise 3D registration of said digital data files representing said medical images; and
(c) identifying one or more lesions which is present in one of said medical images and also present in at least one previous image.

27. A method according to claim 26, wherein the number of medical images is 2.

28. A method according to claim 26, wherein the number of medical images is 3 to 10.

29. A method according to claim 26, wherein said identifying relies on model-based, machine learning and/or deep learning classifier.

30. A method according to claim 26, comprising detecting lesions in each of said medical images, wherein said lesion changes detection relies on one or more algorithms selected from the group consisting of baseline pairwise analysis; sequential pairwise analysis, simultaneous group-wise analysis.

31. A method according to claim 26, wherein said 3d registration employs NiftyReg and/or GLIRT (Group-wise and Longitudinal Image Registration Toolbox) libraries.

32. A method according to claim 26, comprising presenting at least one of said medical images in a graphical user interface which indicates each lesion which is present in one of said images and also present in at least one previous image graphically.

33. A method according to claim 26, comprising using a data processor to generate a report indicating a change in volume for each lesion which is present in one of said images and also present in at least one previous image.

34. A method according to claim 26, comprising visually representing a change in volume for each lesion which is present in one of said images and also present in at least one previous image.
